(19) United States
(12) Patent Application Publication
(10) Pub. No.: US 2013/0325960 A1
(43) Pub. Date: Dec. 5, 2013

(54) CLIENT-SIDE SHARING OF EVENT INFORMATION

(71) Applicant: INTERNATIONAL BUSINESS MACHINES CORPORATION, Armonk, NY (US)

(72) Inventors: Shubham Agarwal, Gurgaon (IN); Manu Kuchhal, Gurgaon (IN); Shailendra K. Sason, Allahabad (IN)

(73) Assignee: INTERNATIONAL BUSINESS MACHINES CORPORATION, Armonk, NY (US)

(21) Appl. No.: 13/893,591

(22) Filed: May 14, 2013

Related U.S. Application Data
(63) Continuation of application No. 13/485,141, filed on May 31, 2012.

(51) Int. Cl. H04L 29/06

(52) U.S. Cl. CPC H04L 65/40
USPC 709/204

(57) ABSTRACT

Client-side sharing of event information. Via a service hub executed on a client device, an event generated by a first web application accessed by the client device can be received and communicated to a second web application accessed by the client device or communicated to a native application executed on the client device. The event is not routed through a server.

### BACKGROUND

Arrangements described herein related to the handling of events generated by applications.

Since the advent of Web 2.0, there has been a growing shift from the use of desktop applications, which are applications executed on a local client computing device, to web applications. A web application is an application that is accessed over a communication network, such as the Internet or an intranet. Oftentimes web applications are coded using a browser-supported language, such as JavaScript, which may be combined with a browser supported language, such as HTML.

Web applications have become popular due to the ubiquity of web browsers and the convenience of using a web browser as a web client. The ability to update and maintain web applications without distributing and installing software on large numbers of client computers is a key reason for their popularity, as is the inherent support for cross-platform compatibility. Webmail, online retail sales applications, online auction applications and wikis are some examples of web applications, but there are a myriad of other types of web applications currently available, and new web applications are continually being developed.

### BRIEF SUMMARY

One or more embodiments disclosed within this specification relate to client-side sharing of event information.

An embodiment can include, via a service hub executed on a client device, receiving an event generated by a first web application accessed by the client device and, via the service hub, communicating the event generated by the first web application to a second web application accessed by the client device, wherein the event is not routed through a server.

Another embodiment can include, via a service hub executed on a client device, receiving an event generated by a web application accessed by the client device and, via the service hub, communicating the event generated by the web application to a native application executed on the client device, wherein the event is not routed through a server.

Another embodiment can include a client device having a processor. The processor can be configured to initiate executable operations including the processes and/or functions described herein.

Another embodiment can include a computer program product for client-side sharing of event information. The computer program product can include a computer-readable storage medium having stored thereon program code that, when executed, configures a processor to perform operations including the processes and/or functions described herein.

### BRIEF DESCRIPTION OF THE SEVERAL VIEWS OF THE DRAWINGS

FIG. 1 is a block diagram illustrating a system for client-side sharing event information in accordance with one embodiment disclosed within this specification.

FIG. 2 is a block diagram illustrating event publication and subscription in accordance with one embodiment disclosed within this specification.

FIG. 3 is a block diagram illustrating a client device in accordance with one embodiment disclosed within this specification.

FIG. 4 is a flow chart illustrating a method of client-side sharing event information in accordance with another embodiment disclosed within this specification.

FIG. 5 is a flow chart illustrating another method of client-side sharing event information in accordance with another embodiment disclosed within this specification.

FIG. 6 is a flow chart illustrating another method of client-side sharing event information in accordance with another embodiment disclosed within this specification.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

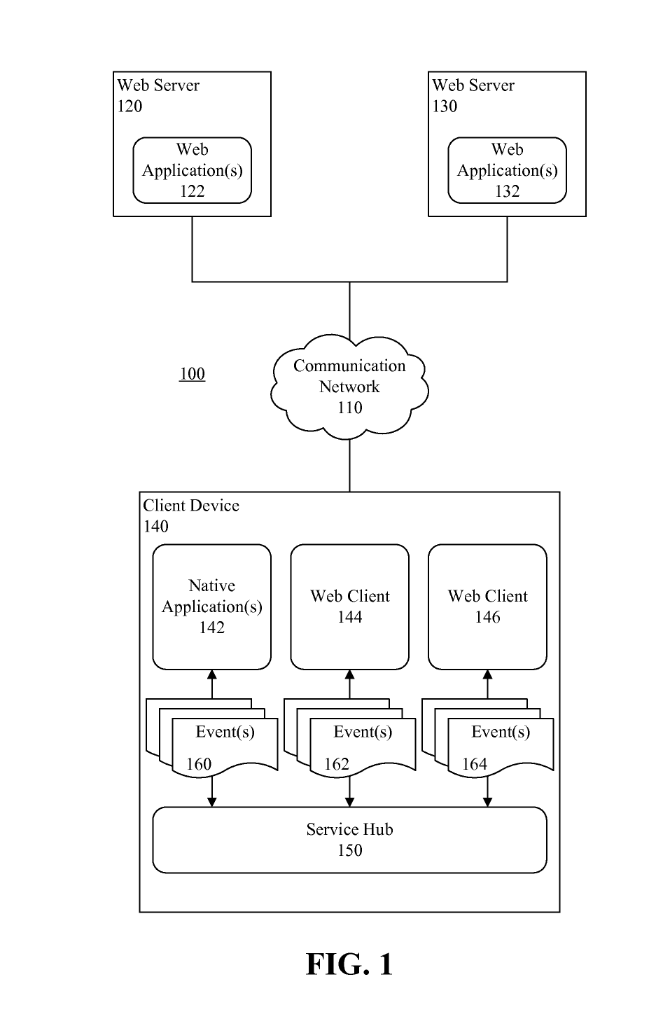

FIG. 1 is a block diagram illustrating a system 100 for client-side sharing event information in accordance with one embodiment disclosed within this specification. The system 100 can include a communication network 110, one or more web servers 120, 130, and a client device (hereinafter “client”) 140 communicatively linked to the one or more web servers 120, 130 via the communication network 110.

The communication network 110 can be a private communication network, a public communication network, or a combination of a private communication network and a public communication network. A private communication network can be a local area network (LAN), a wide area network (WAN), an intranet, and/or any other communication network private to a particular entity. A public communication network can comprise the Internet, a cellular communication network, or any other communication network that is publically accessible.

Each web server 120, 130 can be implemented as server software, such as an operating, executing on one or more suitable processing systems comprising at least one processor and memory (e.g., server hardware). Each web server 120, 130 can be executed directly on a particular processing system or virtualized across one or more processing systems, as is known to those skilled in the art. Each web server 120, 130 can provide one or more web applications. For example, the web server 120 can provide a web application 122 and the web server 130 can provide a web application 132. As used herein, the term “web application” means an application provided by a web server that is accessible from a client device via a public communication network and/or a private communication network. The source code for the web application is server side (i.e., generally not intended to be permanently stored on the client device or a storage device directly connected to the client device). In this regard, during a client session, a web server can dynamically provide to a client program code for an application, and the application program code can be executed locally by the client. The web server need not provide the entire application program code to the client, but instead need only provide portions of the application program code corresponding to application functions being used by the client. The client can temporarily store the application program code in memory.

The client 140 can be a general purpose computer (e.g., a workstation, a desktop computer, or the like), a mobile computing device (e.g., a mobile station such as a laptop computer, a notebook computer, a mobile computer, a tablet computer, a personal digital assistant (PDA), a smart phone, a mobile terminal, etc.), an application specific device, or any other client-side processing system comprising at least one processor and memory that is configured to process event information.

The client 140 can execute one or more native applications 142 and/or one or more web clients 144, 146. As used herein, the term “native application” means an application that executes on a client device, wherein the source code for the application is client side (i.e., stored on a storage device within the client device or on a storage device directly connected to the client device). The native application(s) 142 can be executed directly by an operating system executing on the client 140 or another framework executed on the operating system, for example via a virtual machine.

As used herein, the term “virtual machine” means a portion of a computer system that is controlled by an operating system (e.g., a guest operating system) and functions as though it were a complete system, although in reality the computer is shared with at least one other independent operating system. Examples of virtual machines include, but are not limited to system virtual machines (e.g., guest instances of Windows®, OSX®, Linux™, and the like) and process virtual machines (e.g., the Java™ Virtual Machine, .NET framework, and the like), though the present arrangements are not limited to these examples.

As used herein, the term “web client” means a client-side application that executes on a client device and is configured to execute program code received from a web server. In addition, a “web client” also may be configured to execute program code native on the client 140. Example of web clients include web browsers, such as Internet Explorer®, Firefox®, Chrome™, Safari® and Opera™, though the present arrangements are not limited to these examples. The web clients 144, 146 can include one or more plugins, which are known to those skilled in the art. In one arrangement, a plugin can be a virtual machine plugin (e.g., a Java™ plugin, .NET plugin, etc.) to provide a bridge between the web applications 122, 132 and the respective web clients 144, 146, though the present arrangements are not limited in this regard. Silverlight® is another plugin known in the art, though numerous other plugins are readily available and are within the scope of the present embodiments.

The client 140 also can execute a service hub 150. The service hub 150 can be configured to handle communications among the native application(s) 142 and the web applications 122, 132 (when the web applications are executed on the client 140 by the respective web clients 144, 146), as will be described. The service hub 150 can implemented using the Open Source Gateway Initiative (OSGI) runtime environment, the Java™ runtime environment, the .NET framework, or any other suitable framework.

In operation, the client 140 can execute two or more applications selected from the native application(s) 142 and the web clients 144, 146. In illustration, the web client 144 can receive program code from the web application 122 and the web client 146 can receive program code from the web application 132, and the web clients 144, 146 can execute the respective web applications 122, 132. As noted, the web applications 122, 132 can be applications configured to be executed by virtual machines (e.g., Java™ runtime environment), though this need not be the case. For example, one or more of the web applications 122, 132 can be Java™ applications.

The web clients 144, 146 can be different applications, for example different web browsers, or can be different instances of the same application. For example, the web client 144 can be a first instance of a web browser presented in a first tab of the web browser and the web client 146 can be an instance of the web browser presented in a second tab of the same web browser. In another example, the web clients 144, 146 can be presented in different browser windows. The different browser windows can be associated with different instances of the same browser, or associated with respective instances of different browsers.

During execution, the native application(s) 142 can generate respective events 160. Further, the web applications 122, 132, while being executed by the respective web clients 144, 146, can generate respective events 162, 164. As used herein, the term “event” means a specified state of change of an application. For example, an event can be generated by an application 122, 132, 142 upon completion of an input and/or output operation to mark completion of the operation.

When the events 160-164 are generated by the respective applications 122, 132, 142, the events 160-164 can be communicated to the service hub 150, which can communicate the events 160-164 to other applications 122, 132, 142 subscribed to the events. The service hub 150 also can persist the events 160-164 to a data storage device. For example, the events 160-164 can be persisted before the events 160-164 are communicated to the other applications 122, 132, 142. At this point it should be noted that the events 160-164 need not be routed through the web servers 120, 130, thereby freeing the web servers 120, 130 from performing such tasks and improving system responsiveness by eliminating the need to communicate events via the communication network 110.

In illustration, the events 160 can be communicated from the native application(s) 142 to the service hub 150, and the service hub 150 can communicate the events 160 to other native application(s) 142 and/or to the web application(s) 122, 132 (while executing via the web client(s) 144, 146) that are subscribed to the events 160. Similarly, the events 162 can be communicated from web application 122 to the service hub 150, and the service hub 150 can communicate the events 162 to the native application(s) 142 and/or to other web application(s) 132 that are subscribed to the vents 162. Further, the events 164 can be communicated from web application 132 to the service hub 150, and the service hub 150 can communicate the events 164 to the native application(s) 142 and/or to other web application(s) 122 that are subscribed to the events 164.

The communication of the events 160-164 via the service hub 150 can be independent of the underlying operating system executing on the client 140 and the programming model used by the operating system. In this regard, each of the applications 122, 132, 142 can execute in their respective execution environments, yet exchange information via the events 160-164 in a seamless manner.

To facilitate communications between the service hub 150 and the web client(s) 144, 146, plugins can be provided for the web clients 144, 146. For example, the plugins can be configured in accordance with ActiveX, MFC, XPConnect, XPCOM, or any other suitable plugin format. Java™ archive (JAR) files and/or Java script application program interfaces (APIs) also can be provided to support communication between the service hub 150 and the applications 122, 132, 142 that are Java™ based applications. The Java script APIs can, for example, provide to an application developer standard calls/methods that can be used for communication between the applications 122, 132, 142 and the service hub 150 and perform various event related actions.

Further, suitably configured socket components can be provided for the applications 122, 132, 142 to support socket communications between the service hub 150 and the applications 122, 132, 142. Also, one or more dynamic link libraries (DLLs) and/or shared object (SO) files can be provided to support communications between the applications 122, 132, 142 and the service hub 150. In illustration, the DLLs and/or SO files can provide a mechanism for the applications 122, 132, 142 to connect to the service hub 150 and register event monitoring and/or to subscribe to events.

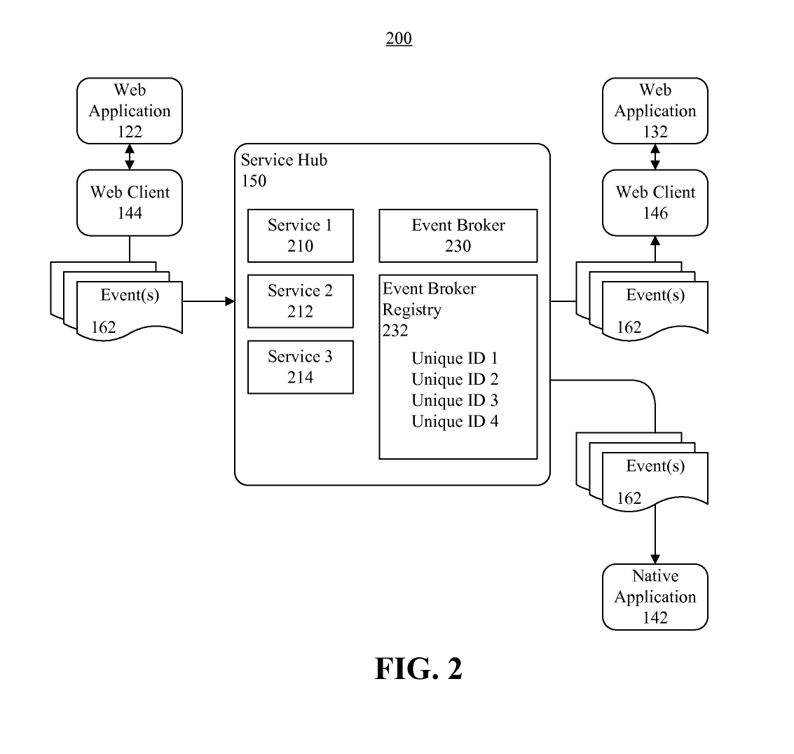

FIG. 2 is a block diagram 200 illustrating event publication and subscription via the service hub 150 in accordance with one embodiment disclosed within this specification. The service hub 150 can host one or more services 210, 212, 214. The services 210-214 can be configured to intercept operating system hooks, capture events (e.g., file create, delete and/or modify events), or configured to perform any other suitable operations. In this regard, the services 210-214 can interface with an event broker 230, which itself can interface with an event broker registry 232, to detect published events.

In illustration, when initialized, the applications 122, 132, 142 can indicate to the service hub 150 (e.g., to the event broker 230) whether they are event publishers and/or event subscribers. Further, the applications 122, 132, 142 can indicate to the service hub 150 (e.g., to the event broker 230) which events they choose to publish and which events to which they choose to subscribe. For example, the applications 122, 132, 142 can indicate that they choose to publish all events, certain events, or no events. Similarly, the applications 122, 132, 142 can indicate that they choose to subscribe to all events generated by other applications 122, 132, 142, certain events, or no events. For example, the web application 132 can choose to subscribe to all published events generated by other applications 122, 142, to subscribe only to published events generated by certain applications 122, 142, to subscribe only certain types of published events, or to only subscribe only to certain types of events published by certain applications 122, 142. The event broker 230 can associate such selections with unique identifiers corresponding to the respective applications 122, 132, 142 within the event broker registry 232.

When the web application 122 chooses to publish events 162, the web application 122 can send its unique identifier (ID) to the event broker 230 with an indication of which events 162 the web application 122 chooses to publish, for example via remote procedure calls. Optionally, the web application 122 also can indicate with which other applications 132, 142 it chooses to share the events 162. In the event broker registry 232, the event broker 230 can create or find the unique ID associated with the web application 122, and associate the event publication selections with the unique ID.

Via the event broker 230, the applications 132, 142 can choose to subscribe to the events 162 published by the web application 122. In illustration, the event broker 230 can receive a request from the web application 132, via the web client 146, to subscribe to the events 162. The event broker 230 can associate a unique ID corresponding to the web application 132 with the events 162 in a suitable manner. In this regard, the event broker 230 can map a unique ID for each application subscribing to an event to each application publishing the event.

By way of example, when the web application 122 generates the events 162, the web client 144 can communicate the events 162 to the service hub, for example using a remote procedure call (RPC) initiated by a plugin in the web client 144. The service hub 150 can persist the event to a data storage device. Further, the event broker 230 can access the event broker registry 232 to identify the unique IDs of other applications 142, 162 subscribing to the events 162, and can communicate the events 162 to such other applications 142, 162.

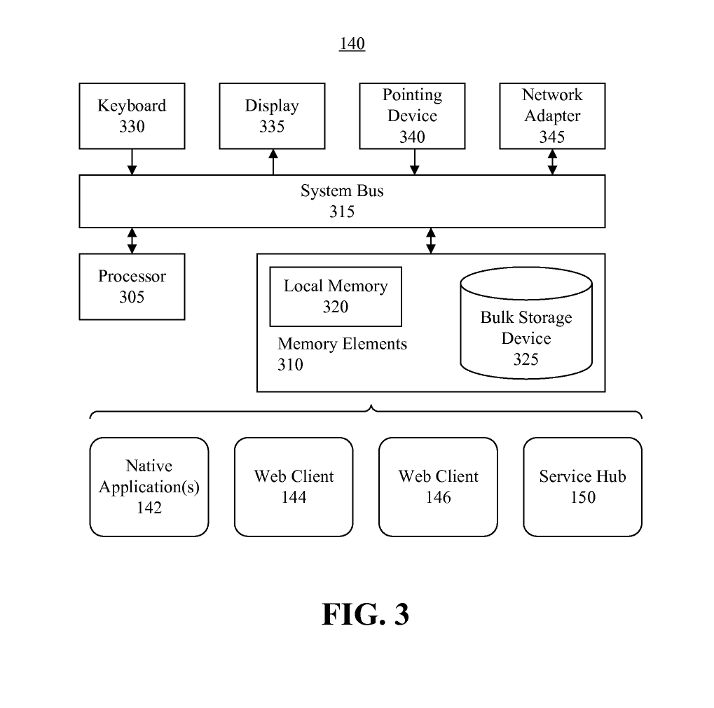

FIG. 3 is a block diagram illustrating the client device 140 of FIG. 1 in accordance with one embodiment disclosed within this specification. The client 140 can include at least one processor 305 coupled to memory elements 310 through a system bus 315 or other suitable circuitry. As such, the client 140 can store program code within memory elements 310. The processor 305 can execute the program code accessed from memory elements 310 via the system bus 315. As noted, that the client 140 can be implemented in the form of any system including a processor and memory that is capable of performing the functions and/or operations described within this specification.

The memory elements 310 can include one or more physical memory devices such as, for example, local memory 320 and one or more bulk storage devices 325. Local memory 320 refers to RAM or other non-persistent memory device(s) generally used during actual execution of the program code. The bulk storage device(s) 325 can be implemented as a hard disk drive (HDD), solid state drive (SSD), or other persistent data storage device. The client 140 also can include one or more cache memories (not shown) that provide temporary storage of at least some program code in order to reduce the number of times program code must be retrieved from the bulk storage device 325 during execution.

Input/output (I/O) devices such as a keyboard (or keypad) 330, a display 335, and a pointing device 340 optionally can be coupled to system 100. The I/O devices can be coupled to system 100 either directly or through intervening I/O controllers. One or more network adapters 345 also can be coupled to the client 140 to enable the client 140 to become coupled to other systems, computer systems, remote printers, and/or remote storage devices through intervening private or public networks. Modems, cable modems, and Ethernet cards are examples of different types of network adapters 345 that can be used with the client 140.

As pictured in FIG. 3, the memory elements 310 can store the native application(s) 142, the web clients 144, 146 and service hub 150. Being implemented in the form of respective executable program code, the native application(s) 142, web clients 144, 146 and service hub 150 can be executed by client 140 and, as such, can be considered part of client 140. The native application(s) 142, web clients 144, 146 and service hub 150 can, collectively, implement the various processes and functions described herein.

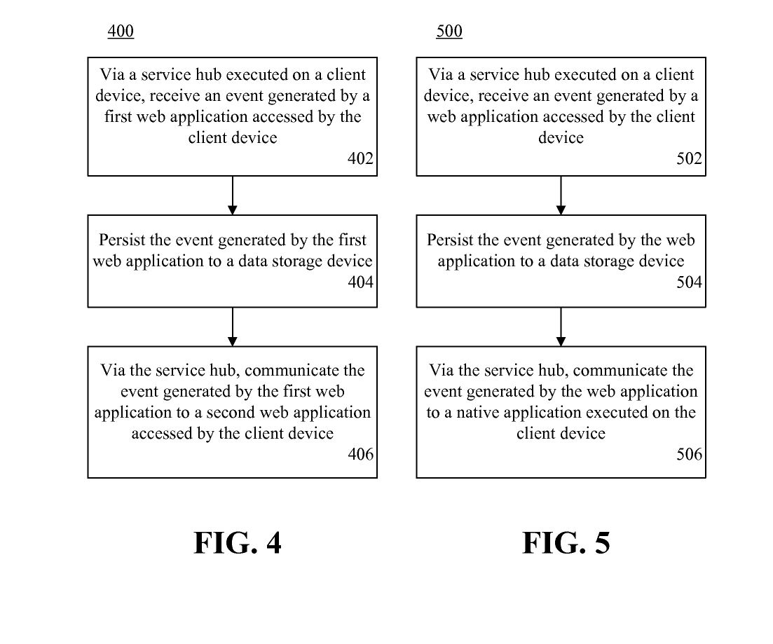

FIG. 4 is a flow chart illustrating a method 400 of client-side sharing event information in accordance with another embodiment disclosed within this specification. At step 402, via a service hub executed on a client device, an event generated by a first web application accessed by the client device can be received. At step 404, the event generated by the first web application can be persisted to a data storage device. At step 406, via the service hub, the event generated by the first web application can be communicated to a second web application accessed by the client device.

FIG. 5 is a flow chart illustrating another method 500 of client-side sharing event information in accordance with another embodiment disclosed within this specification. At step 502, via a service hub executed on a client device, an event generated by a web application accessed by the client device can be received. At step 504, the event generated by the web application can be persisted to a data storage device. At step 506, via the service hub, the event generated by the web application can be communicated to a native application executed on the client device.

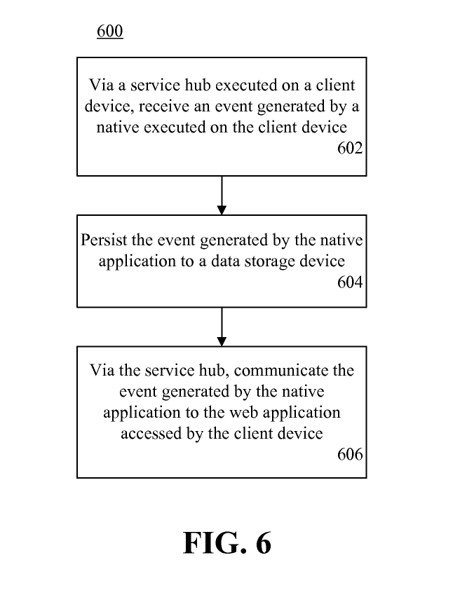

FIG. 6 is a flow chart illustrating another method 600 of client-side sharing event information in accordance with another embodiment disclosed within this specification. At step 602, via a service hub executed on a client device, an event generated by a native application executed on the client device can be received. At step 604, the event generated by the native application can be persisted to a data storage device. At step 606, via the service hub, the event generated by the native application can be communicated to a web application accessed by the client device.

Like numbers have been used herein to refer to the same items throughout this specification. The flowcharts and block diagrams in the Figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “include” and/or “including,” when used in this specification, specify the presence of stated features, integers, steps, operations, elements, and/or components, but do not preclude the presence or addition of one or more other features, integers, steps, operations, elements, components, and/or groups thereof.

Reference throughout this specification to “one embodiment,” “an embodiment,” or similar language means that a particular feature, structure, or characteristic described in connection with the embodiment is included in at least one embodiment disclosed within this specification. Thus, appearances of the phrases “in one embodiment,” “in an embodiment,” and similar language throughout this specification may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The corresponding structures, materials, acts, and equivalents of all means or step plus function elements in the claims below are intended to include any structure, material, or act for performing the function in combination with other claimed elements as specifically claimed. The description of the embodiments disclosed within this specification have been presented for purposes of illustration and description, but are not intended to be exhaustive or limited to the form disclosed. Many modifications and variations will be apparent to those of ordinary skill in the art without departing from the scope and spirit of the embodiments of the invention. The embodiments were chosen and described in order to best explain the principles of the invention and the practical application, and to enable others of ordinary skill in the art to understand the inventive arrangements for various embodiments with various modifications as are suited to the particular use contemplated.

1-15. (canceled)

16. A client device, comprising:
a hardware processor configured to initiate executable operations comprising:
via a service hub executed on the client device, receiving an event generated by a first web application accessed by the client device; and
via the service hub, communicating the event generated by the first web application to a second web application accessed by the client device;
wherein the event is not routed through a server.

17. The client device of claim 16, wherein the hardware processor further is configured to initiate executable operations comprising:
via an event broker, subscribing the second web application to events generated by the first web application.

18. The client device of claim 16, wherein the hardware processor further is configured to initiate executable operations comprising:
via an event broker, publishing events generated by the first web application.

19. The client device of claim 16, wherein the first web application and the second web application are respective instances of a particular web browser.

20. The client device of claim 16, wherein the first web application and the second web application are presented in different tabs of a particular web browser window.

21. The client device of claim 16, wherein the first web application is a first web browser and the second web application is a second web browser.

22. The client device of claim 16, wherein the hardware processor further is configured to initiate executable operations comprising:
persisting the event generated by the first web application to a data storage device:
wherein communicating the event generated by the first web application to the second web application comprises communicating the event to the second web application after the event is persisted to the data storage device.

23. The client device of claim 16, wherein the hardware processor further is configured to initiate executable operations comprising:
via the service hub, communicating the event generated by the first web application to a native application executed on the client device, wherein the event is not routed through a server.

24. A computer program product for client-side sharing of event information, said computer program product comprising:
a computer-readable storage medium having stored thereon program code that, when executed, configures a processor to perform executable operations comprising:
via a service hub executed on a client device, receiving an event generated by a first web application accessed by the client device; and
via the service hub, communicating the event generated by the first web application to a second web application accessed by the client device, wherein the event is not routed through a server.

25. The computer program product of claim 24, wherein the executable operations further comprise:
via an event broker, the second web application subscribing to events generated by the first web application.

26. The computer program product of claim 24, wherein the executable operations further comprise:
via an event broker, the first web application publishing events generated by the first web application.

27-29. (canceled)

30. The computer program product of claim 24, wherein the executable operations further comprise:
persisting the event generated by the first web application to a data storage device:
wherein communicating the event generated by the first web application to the second web application comprises communicating the event to the second web application after the event is persisted to the data storage device.

31. A computer program product for client-side sharing of event information, said computer program product comprising:
a computer-readable storage medium having stored thereon program code that, when executed, configures a processor to perform executable operations comprising:
via a service hub executed on a client device, receiving a first event generated by a web application accessed by the client device; and
via the service hub, communicating the first event generated by the web application to a native application executed on the client device, wherein the event is not routed through a server.

32. The computer program product of claim 31, wherein the executable operations further comprise:
via an event broker, the native application subscribing to events generated by the web application.

33. The computer program product of claim 31, wherein the executable operations further comprise:
via an event broker, the web application publishing events generated by the web application.

34. The computer program product of claim 31, wherein the executable operations further comprise:
persisting the first event generated by the web application to a data storage device:
wherein communicating the first event generated by the web application to the native application comprises communicating the first event to the native application after the first event is persisted to the data storage device.

35. The computer program product of claim 31, wherein the executable operations further comprise:
via the service hub executed on the client device, receiving a second event generated by the native application; and
via the service hub, communicating the second event generated by the native application to the web application executed on the client device, wherein the event is not routed through a server.

36. The client device of claim 16, wherein the hardware processor further is configured to initiate executable operations comprising:
via an event broker, a native application executed on the client device subscribing to events generated by the first web application; and
via the service hub, communicating an event generated by the native application executed on the client device to the first web application, wherein the event is not routed through a server.

37. The computer program product of claim 24, wherein the executable operations further comprise:
via the service hub, communicating the event generated by the first web application to a native application executed on the client device, wherein the event is not routed through a server.

38. The computer program product of claim 24, wherein the executable operations further comprise:
via an event broker, a native application executed on the client device subscribing to events generated by the first web application; and
via the service hub, communicating an event generated by the native application executed on the client device to the first web application, wherein the event is not routed through a server.
